(19) United States
(12) Patent Application Publication
(10) Pub. No.: US 2026/0303400 A1
(43) Pub. Date: Oct. 1, 2026

(54) System for Managing Energy Consumption in Household Appliances and Electrically Powered Devices

(71) Applicants: Justin Rhoads, taylor, AZ (US); Jack Lee Rhoads, Tucson, AK (US)

(72) Inventors: Justin Rhoads, taylor, AZ (US); Jack Lee Rhoads, Tucson, AK (US)

(21) Appl. No.: 19/095,325

(22) Filed: Mar. 31, 2025

(51) Int. Cl. H04L 12/28

(52) U.S. Cl. CPC H04L 12/2816

(57) ABSTRACT

The present invention relates to a system and method for managing energy consumption among household appliances or electrically powered devices that operate simultaneously. The system monitors and controls the operational state of multiple high-power devices, toggling between full and partial operation based on real-time conditions, device status, and assigned priority. A microprocessor or analog control board communicates with switching devices, such as relays or transistors, to activate or deactivate components within the appliances. The system ensures that at least one device remains fully operational while another is at least partially non-operational at any given time, thereby reducing peak power demand and enhancing energy efficiency. The system can be integrated into existing power infrastructure, supports wireless communication and programming, and is adaptable to various appliance types including HVAC systems, dryers, water heaters, and electric vehicle chargers.

### BACKGROUND OF THE INVENTION

### 1. Field of the Invention

The present invention relates to systems and methods for managing the energy consumption of household appliances and other electrically powered devices. More specifically, the invention focuses on a system for controlling the operation of multiple devices simultaneously, toggling between fully operational and partially non-operational states to optimize energy use and reduce peak power load.

Many household appliances and electrical devices require substantial power to operate. When multiple devices with significant power requirements are operating at the same time, they can cause a significant spike in electrical demand, especially during peak usage times. This is particularly problematic when using power sources with limited capacity, such as residential power panels, systems with solar or backup generators.

This invention provides an energy management system that optimizes the simultaneous operation of multiple appliances and powered devices by toggling their operational states, reducing power consumption, and preventing overloading of electrical circuits.

### BRIEF SUMMARY OF THE INVENTION

The invention presents a system for managing energy consumption in household appliances or electrically powered devices using, but not limited to, existing power panels and circuit breakers. The system involves monitoring and controlling the operation of at least two appliances or devices with significant power requirements that operate simultaneously. At least one device is fully operational, while another is partially non-operational.

The system includes a microprocessor or analog control board that monitors the status of the appliances or devices, along with a relay switch, transistor, or other switching devices to activate or deactivate components within each device. The appliances toggle automatically between full and partial operation to optimize energy usage.

### BRIEF DESCRIPTION OF THE DRAWINGS

For a fuller understanding of the nature and objects of the invention, reference should be made to the following detailed description taken in conjunction with the accompanying drawings, in which:

FIG. 1. Shows a chart of possible combinations of operational status. This better gives an understanding of the concept of loads being anywhere from fully non-operational to fully operational.

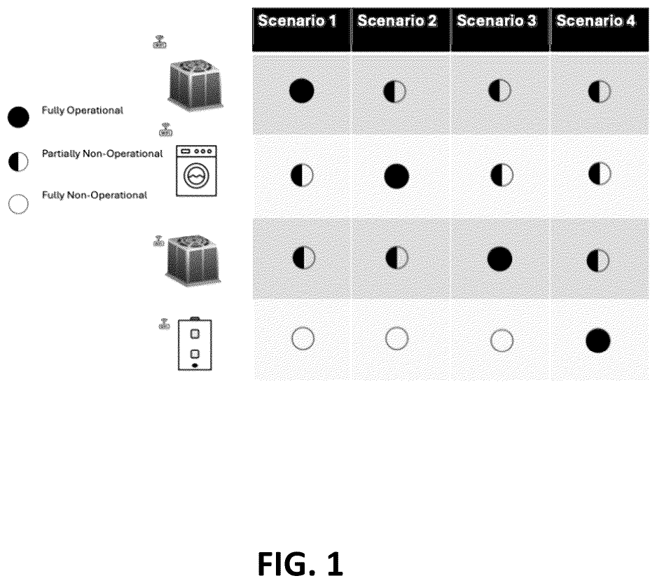

FIG. 2. Shows how each device can communicate directly to each other in a peer-to-peer network, as well as potential WiFi capability.

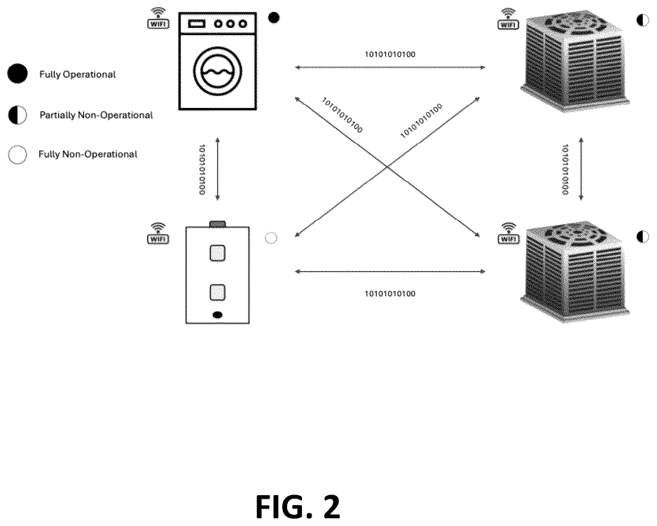

FIG. 3. Shows how a central process could be implemented to check operational status and send commands for to adjust operational status.

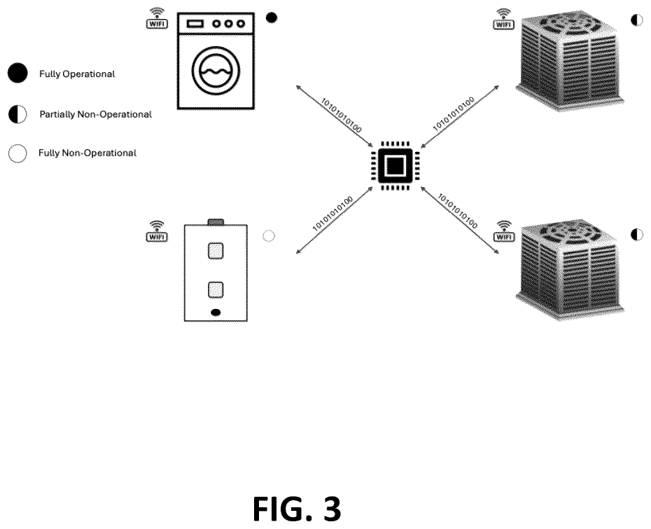

FIG. 4. Shows some of the potential ways devices may be controlled.

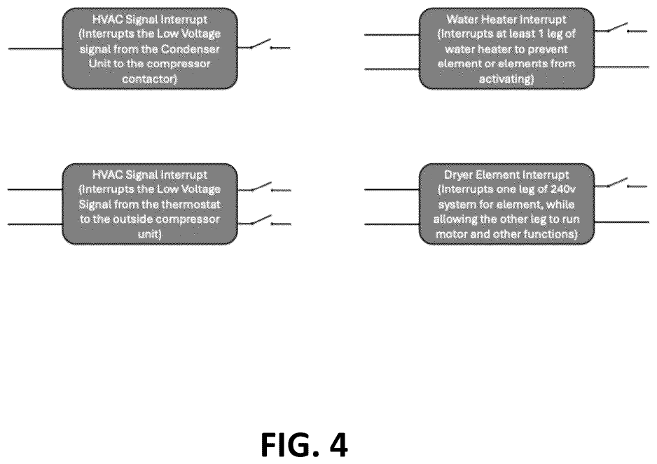

FIG. 5. Shows a scenario in which all major loads can be operational with a smaller generator than would normally be needed.

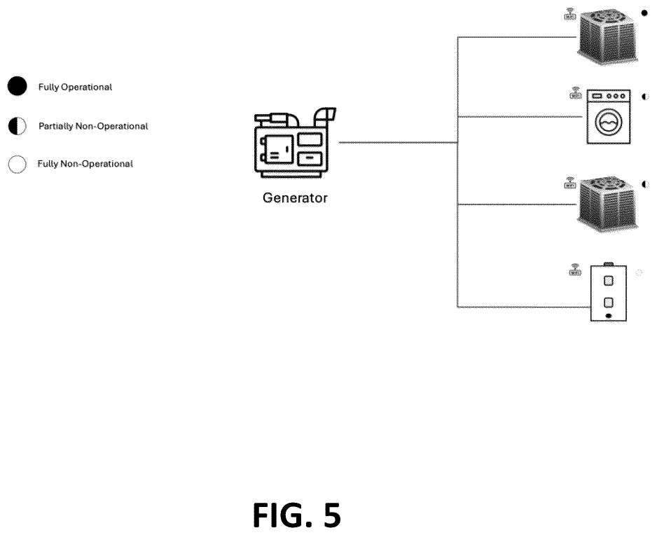

FIG. 6. Shows the difference of energy consumption from the grid or main power supply with solar and how less energy is drawn from main power with this patent.

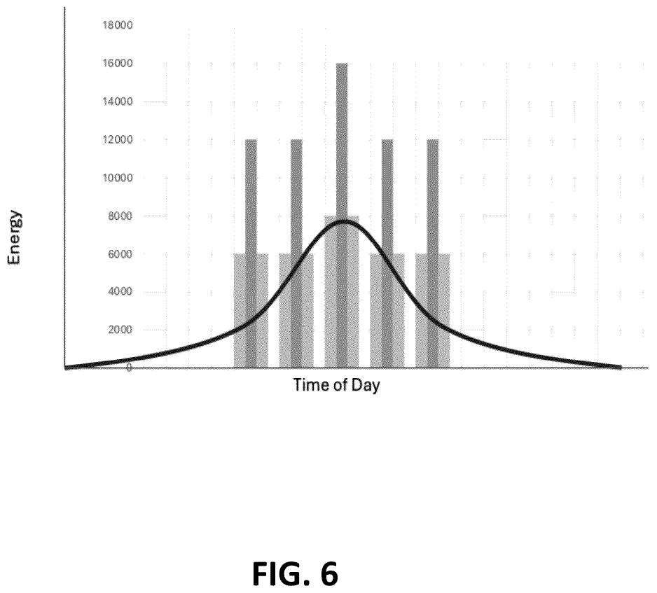

FIG. 7. Shows how the total power consumption is not changed, however peak draw is less.

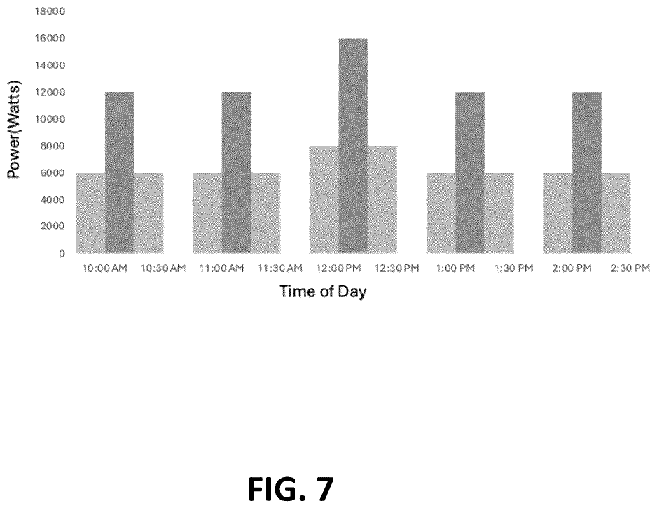

FIG. 8. Shows comparative grid draw and sell back with the same total power consumption.

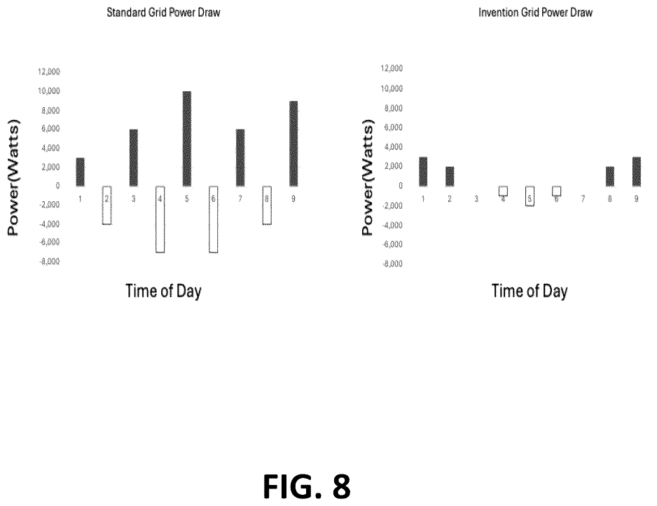

### DETAILED DESCRIPTION

System Components: The invention consists of a system designed to manage the operation of household appliances and electrically powered devices. The system's primary goal is to reduce peak electrical load while maintaining functional operation of appliances. The system achieves this by controlling when each appliance is fully operational or partially non-operational.

Appliances and Devices: The system works with at least two appliances or devices, such as HVAC systems, clothes dryers, water pumps, and other high-power appliances. These devices are managed to operate simultaneously without overloading the power supply.

Microprocessor or Control Board: A microprocessor or analog control board continuously monitors the status of each appliance or device, gathering information on power consumption, operational state, and other relevant data. This allows the system to toggle devices between full and partial operational states based on the monitored data.

Relay Switch/Transistor or Other Switching Device: Each appliance is equipped with a relay switch, transistor, or other switching mechanism controlled by the microprocessor or analog control board. This allows the system to deactivate or activate individual components within the appliances to optimize energy consumption.

Toggling Between Full and Partial Operation: The appliances toggle automatically between full and partial operational states to reduce peak load. For example, when one device is fully operational, another may be partially non-operational, such as a heating element in a dryer being deactivated while the dryer continues to operate.

How the system operates: Fully Operational State: An appliance is considered fully operational when its main power component is activated. For example, the HVAC compressor, clothes dryer heating element, or water pump motor is fully engaged.

Partially Non-Operational State: An appliance is considered partially non-operational when at least one electrical component is deactivated in a way that significantly reduces its power consumption. For example, a clothes dryer may deactivate its heating element, while other components such as the drum continue to operate.

Priority of Operation: Each appliance or electrically powered device is assigned a priority level, which determines the order in which the appliances and their components are activated or deactivated relative to other devices. This prioritization ensures that critical appliances are always operational when necessary.

Continuous Power Supply: A power source with circuit breakers ensures continuous power to all appliances during and after activation or deactivation, preventing interruptions in service while still managing the overall load.

Wireless Control: The control switches and processors can be controlled wirelessly through Bluetooth, Wi-Fi, LAN, or WAN from devices like smartphones, tablets, or computers. This flexibility enables remote programming or reprogramming of the system, making it adaptable to varying energy needs.

What is claimed is:

1-33. (canceled)

34. A method for managing energy consumption to reduce peak power loads caused by household appliances or other electrically powered devices, comprising:
providing an electrically powered appliance that includes a power component adapted to be utilized by devices requiring electrical power;
providing a controller that includes a microprocessor adapted to control a switch programmed and adapted for monitoring and managing the operational status of said devices;
wherein said controller is adapted for communicating with at least one other controller that is adapted to monitor and manage at least one of said devices, to thereby manage the operational status of at least two of said devices, or to synchronize the operational toggling of at least two of said devices;
wherein monitoring said devices includes tracking the operational status of at least one of said devices;
wherein managing said devices includes activating or deactivating, or allowing activation or deactivation, of at least one component of at least one of said devices;
wherein said controller is programmed to be capable of automatically activating or deactivating, or allowing activation or deactivation, of at least one power component of at least one of said devices;
wherein said controller is programmed to be capable of allowing at least one of said devices to be fully operational, while preventing at least one other of said devices from being fully operational, wherein at least one of said devices is fully operational, while at least one other of said devices is at least partially non-operational at the same time, to manage the operational status of at least two of said devices, or to synchronize the operational toggling of at least two of said devices;
wherein a said controller is programmed to be capable of automatically exchanging the operational status of at least two of said devices, so that a partially or fully non-operational device becomes a fully operational device, while a fully operational device becomes a partially or fully non-operational device;
wherein, after said exchange, at least one of said devices is fully operational, while at least one other of said devices is partially or fully non-operational at the same time, in order to manage the operational status of at least two of said devices, or to synchronize the operational toggling of at least two of said devices; and
wherein said controller is programmed to be capable of automatically and consecutively exchanging the said operational status of at least two of said devices multiple times, as they systematically toggle back and forth together, wherein said toggling continues until it is interrupted by at least one said programmed controller.

35. (canceled)

36. The method of claim 34, wherein said controller is connected to a temperature regulator.

37. The method of claim 34, wherein at least one of said controllers is connected to a device requiring a thermostat or temperature regulator.

38. The method of claim 34, wherein at least one said controller is either connected to or made a part of a said electric hot water heater.

39. The method of claim 34, wherein at least one said controller is either connected to or made a part of a said electric clothes dryer.

40. The method of claim 34, wherein at least one said controller is either connected to or made a part of a said electric range or oven.

41. The method of claim 34, wherein at least one said controller is either connected to or made a part of a said electric vehicle charger.

42. (canceled)

43. The method of claim 34, wherein at least one said controller is, but not limited to, connected to or made a part of a said device, or connected to or made part of a thermostat or temperature regulator monitoring or managing the demand signals to a said device, or remotely located from a said device, or used as a hub to transmit information to and from other said controllers to manage the operational status of multiple devices, or integrated into a male and female plug positioned between a wall outlet and said device.

44. The method of claim 34, wherein a common power source with circuit breakers continues to provide continuous power to all devices during and after activation and deactivation of said components.

45. The method of claim 34, wherein at least one said controller monitors the power consumption or production of a said power source for all information beneficial for monitoring and managing the operational status of all said devices.

46. The method of claim 34, wherein said controllers are wirelessly controlled or hard wired, and may be programmed, or re-programmed via Bluetooth, WiFi, LAN, or WAN from a computer, iPad, iPhone, or other connected devices.

47. The method of claim 34, wherein at least two said devices share the same operational status for a period of time either before, during or after said toggling.
